(19) United States
(12) Patent Application Publication
(10) Pub. No.: US 2012/0120775 A1
(43) Pub. Date: May 17, 2012

(54) DRIVING MECHANISM FOR WATCH MOVEMENT

(76) Inventors: Christophe AVRIL, Foucherant (FR); Dominique Perreux, Pirey (FR); Jean-Michel Tisserand, Choissey (FR)

(21) Appl. No.: 13/291,540

(22) Filed: Nov. 8, 2011

(30) Foreign Application Priority Data
Nov. 17, 2010 (CH) 01923/10

(51) Int. Cl. G04B 1/16

(52) U.S. Cl. 368/142

(57) ABSTRACT

Driving mechanism for watch movement having: a barrel mounted on an arbor so as to be capable of turning around an axis of the arbor when the driving mechanism is wound up. A mainspring unit has a first and second spring coiled up inside the barrel in superimposed fashion and coaxial one relative to the other. The first and second springs are coupled at one of their extremities to the barrel and to the arbor, respectively. The unit has a plate mounted coaxially between the two springs, and mounted rotatively on the axis. The first and second springs are coupled at their other extremity to the centre and to the periphery of the plate, respectively, so that the two springs simultaneously wind up around the axis when the driving mechanism is wound up.

### FIELD OF THE INVENTION

The present invention pertains to a driving mechanism for watch movement having several springs. More particularly, the present invention pertains to a driving mechanism having a power reserve greater than that of conventional driving mechanisms whilst having a long service life and maximizing the restitution of the stored energy.

### STATE OF THE ART

The spiral mainspring is the element for storing the mechanical energy required for the watch to function. Generally, its geometric dimensions and the mechanical properties of the material that constitute it determine the potential energy that the spiral mainspring is capable of storing and the maximum torque it can deliver. In the field of mechanical watch movements, it is well known to replace the usual driving mechanism comprising a single mainspring with a group of two barrels connected serially in order to accumulate a potential energy sufficient to ensure a power reserve greater than the usual approximate 40 hours without affecting the watch's chronometric performance nor the efficiency of the gearing. A detailed explanation of the functional features of such a driving mechanism can be found in patent CH610465, which presents by way of example a stacked arrangement and a juxtaposed arrangement for the barrels. In this patent, it is the stacked arrangement that is chosen, because the torque can be transmitted directly from one barrel to another over a common arbor, which avoids loss of space and of performance due to the return gearing which is required in the juxtaposed arrangement. However, such a driving mechanism suffers from a considerable height due to the superimposition of the barrels.

Patent application EP2060957 describes a driving mechanism with two stacked coaxial barrels, wherein two superimposed springs are connected to a same arbor but belong to the two stacked barrels. In order to minimize the height of the driving mechanism, the barrel covers are replaced with a separation disc made of antifriction material, placed between two springs.

Document U.S. Pat. No. 249,845 describes a driving mechanism using a single barrel drum provided with two superimposed springs, coiled in opposite directions so as to wind or unwind serially. The prings are fastened at their inside extremity to the barrel arbor and at their outside extremity to the drum. The two springs are separated by a separation disc resting on a shoulder of the arbor and holding it in position.

The separation disc described in the two documents here above is however subject to wear and tear, even in the case of the disc being of antifriction material. This wear and tear can be quick, particularly in case of friction of the metallic springs against the disc, and can generate wear and tear debris capable of spreading in a clockwork using the driving mechanism. Furthermore, the separation disc can also be a source of loss of stored energy due to the friction between the superimposed springs and the disc.

### BRIEF SUMMARY OF THE INVENTION

One aim of the present invention is to propose a driving mechanism free of the limitations of the known prior art.

Another aim of the invention is to propose a driving mechanism with a power reserve greater than in conventional driving mechanisms whilst having a low overall height and minimizing the mainsprings' friction and thus wear and tear.

According to the invention, these aims are achieved notably by means of a driving mechanism having a barrel mounted on an arbor so as to be capable of turning around an axis of the arbor when the driving mechanism is wound up; a mainspring unit having a first and second spring coiled up inside the barrel in superimposed fashion and coaxial one relative to the other, wherein the first and second springs are coupled at one of their extremities to the barrel and to the arbor, respectively; wherein the unit further comprises a plate mounted coaxially between the two springs; characterized in that the plate is mounted rotatively on the axis; and in that the first and second springs are coupled at their other extremity to the centre and to the periphery of the plate, respectively, so that the two springs simultaneously wind up around the axis when the driving mechanism is wound up.

In one embodiment, the driving mechanism comprises several mainspring units mounted serially.

In another embodiment, the first and second springs are made of fiber-reinforced polymer.

The driving mechanism of the invention can advantageously be used in a timepiece.

This solution notably affords the advantage over the prior art of achieving a driving mechanism with a low overall height, having a long service life and maximizing the restitution of the stored energy.

### BRIEF DESCRIPTION OF THE FIGURES

Examples of embodiments of the invention are indicated in the description illustrated by the attached figures in which:

FIG. 1 illustrates a driving mechanism according to one embodiment; and

FIG. 2 shows a graph comparing the relation between the torque theoretically delivered depending on the number of turns for a conventional spring made of steel and a spring made of composite material.

### EXAMPLE(S) OF EMBODIMENTS OF THE INVENTION

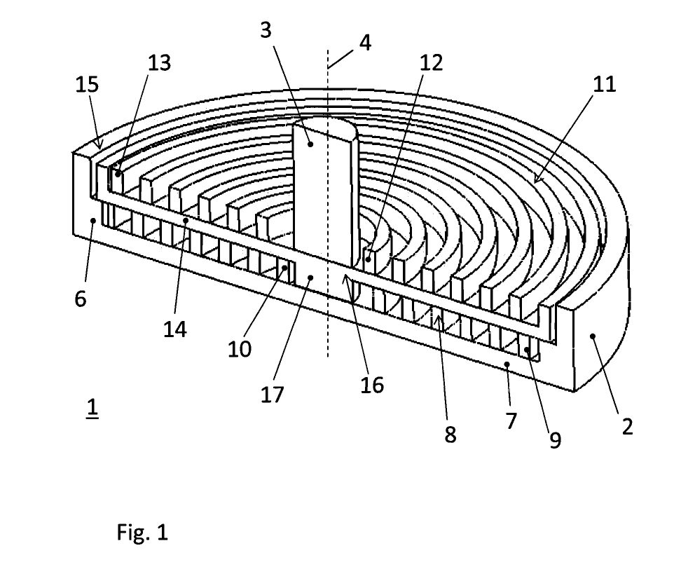

FIG. 1 shows in cross section a driving mechanism 1 according to one embodiment. The driving mechanism 1 comprises a barrel 2 formed of an outer cylindrical drum 6 and of a bottom 7, and capable of having an outer teething (not represented). The barrel 2 is mounted on an arbor 3 so as to be capable of turning freely on an axis 4 of the arbor 3. A first spring 8 and a second spring 11 are mounted in coiled-up fashion inside the barrel 2 in superimposed fashion and coaxial one relative to the other. The two springs 8, 11 typically have the same dimensions and characteristics and are coiled in opposite directions. The barrel 2 also comprises a plate 14 placed between the two springs 8, 11 and which is coaxial with the latter and with the axis 4 of the arbor 3. The plate is mounted in the barrel 2 so as to be able to turn freely around the axis 4. The unit comprising the two springs 8 11 and the plate 14 will also be designated in the rest of the text by the expression “mainspring unit”.

Preferably, the inner extremity 10 of the first spring 8 is coupled to the centre 16 of the plate 14 whilst its outer extremity 9 is fastened to the outer drum 6 of the barrel 2. Here, the expression “at the centre” means a region of the plate in the proximity of its centre, close to the axis 4. The outer extremity 13 of the second spring 11 is coupled to the periphery 15 of the plate 14, whilst its inner extremity 12 is coupled to the arbor 3. The springs 8, 11 are thus mounted serially through the plate 14, the latter serving as kinematic connection between the two springs 8, 11.

In the embodiment shown in FIG. 1, the plate 14 has the shape of a disc with an outer diameter roughly equal to that of the outer drum 6. The plate 14 also comprises a hub 17 engaging in pivoting fashion onto the arbor 3. In this configuration, the hub 16 serves as a core onto which the inner extremity 10 of the first spring 8 is attached. The periphery of the plate 14 can also include an edge 15 onto which the outer extremity 13 of the second spring 11 is attached. The inner extremity 12 of the second spring 11 can also be fastened to the arbor 3 by means of a core (not represented). The plate 14 can be made of plastic material with a low friction coefficient such as PTFE but also of metal, possibly with antifriction coating.

When the driving mechanism 1 is operating, a winding-up mechanism (not represented) can engage onto the outer teething of the barrel 2 so as to make the latter turn around the arbor 3 and wind up the springs 8, 11. More particularly, during winding up, the rotation of the barrel 2 winds up the first spring 8 around the axis 4. The inner extremity 10 of the first spring 8 is fastened to the center of the plate 14, the latter finds itself driven rotatively while the first spring 8 is being wound up. The plate 14 then transmits its torque to the second spring 11 that is thus simultaneously wound up together with the first spring 8 around the axis 4.

As the first and second springs 8, 11 are mounted serially in the barrel 2, the active length of the mainspring unit is effectively doubled for a given diameter by comparison with a conventional arrangement where the barrel comprises a single spring coiled around the arbor 3. The configuration of the driving mechanism 1 thus enables the height and the torque of each of the springs 8, 11 to be divided, for example by a factor of two, whilst storing the same quantity of elastic energy by comparison with conventional springs that are twice as high. It is however also possible to increase the quantity of energy and the power reserve of the mainspring unit for a same total volume of the driving mechanism 1 (i.e. by not changing the height of the springs 8, 11).

In another embodiment, not represented, the driving mechanism 1 comprises several mainspring units mounted serially. In this configuration, the mainspring units can be arranged in superimposed fashion and coaxially one to another; the two springs 8, 11 and the plate 14 of each of the mainspring units being arranged as described here above.

According to another embodiment, not represented, a mainspring unit can have more than two springs, for example three springs with a third spring mounted on a second plate, with both plates being able to turn freely around the axis 4. In this case, the inner extremity of the second spring is coupled to the hub of the second plate, the outer extremity of the third spring is coupled to the periphery of the second plate, and the inner extremity of the third spring is coupled directly to the barrel arbor.

The height of the driving mechanism 1 of the invention, comprising the mainspring unit or units in a same barrel 2, is determined by the height of each of the springs and that of the plate or plates. The driving mechanism 1 can thus be made with a height typically lower than the height of conventional driving mechanisms that would have the same number of mainsprings, in particular in the case of driving mechanisms wherein each spring is comprised in its own barrel. Furthermore, as the plate 14 turns with the first and second springs 8, 11, the friction between the springs 8, 11 and the plate 14 is considerably reduced by comparison with conventional driving mechanisms that have a fixed separation disc. The driving mechanism 1 of the invention thus allows the restitution of the energy stored in the driving mechanism to be maximized.

In another embodiment, the first and second springs 8, 11 are made in a composite material. “Composite material” here means a polymer reinforced with long fibers, such as glass fibers or other. The fibers are preferably oriented unidirectionally in the polymer matrix. Such springs made of composite material can be less likely to break due to fatigue and, consequently, have a longer service life.

The fibers of such a composite spring can be of carbon, glass, aramide or also of another nature (for example of a mixture of fibers) but in any case their axial elasticity module is preferably comprised between 80 GPa and 600 GPa. The fibers generally have the same length as the spring and are arranged in a manner that is as parallel as possible to the long length of the spring. Preferably, the angle between the axis of each fiber and the axis of the spring is as close as possible to 0° and does not exceed 5° locally. The fibers typically have a diameter comprised between 1 μm and 35 μm. A single spring can have fibers of different diameter but preferably the diameters used in the thickness of the spring enable at least ten fibers to be placed side by side in order to achieve a spring with a better homogeneity.

The polymer can be a thermoplastic or a thermal setting plastic (duroplastic). The fraction of fibers in this polymer per volume is preferably comprised between 30% and 756. Nanoparticles can be added into the polymer matrix so as to harden the latter in order to push microbuckling of the fibers back into the compression side of the flexed spring. These nanoparticles can be of silica, fullerenes or any other material that has the ability to bind to polymer resin and increase the latter's resistance to compression without diminishing the polymer resin's ability to bind with the fibers.

Such fiber-reinforced polymer springs can be made, for example, according to a process described in document U.S. Pat. No. 4,464,216, i.e. by filament winding around a mandrel of continuous fibers (graphite, glass etc.) pre-impregnated of thermal setting or thermoplastic matrix. Here, the accumulation of elastic energy in the spiral is achieved by winding one extremity of the spring around the axis 4 of the arbor 3, in a direction opposite to the initial winding onto the mandrel. Furthermore, the profile of the unwound spring is completely determined by the exterior diameter of the mandrel.

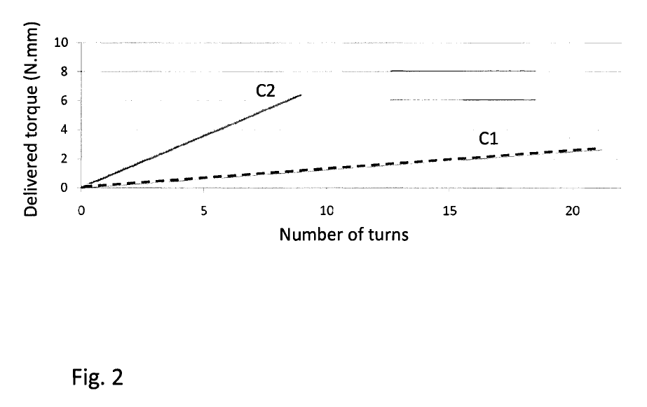

Using said composite materials for making the springs 8, 11 can require the springs to be sized taking into account specificities that differentiate these composite materials from the traditionally used steels. For example, a polymer reinforced with unidirectional glass fibers has an elasticity module approximately four times lower than that of steel for a lower elasticity limit of about half. The sizing of the springs must also take into account application modes of composite materials. Indeed, if steel laminating techniques allow blade thicknesses of less than one tenth of a millimeter, such reduced sizes are difficult to achieve in the case of composite materials in view of the mechanical performance aimed for. Given a constant volume and height of the spring, and given an equivalent stored quantity of energy, a greater thickness of the blade will result in an increase of the maximum torque delivered. This is illustrated by the graph of FIG. 2 comparing the relation between the theoretically delivered torque depending on the number of turns for a spring made of conventional steel (curve C1) and a spring made of composite material (curve C2). This composite material is for example a material comprising an epoxy matrix reinforced with 60% of glass fibers HiPer-tex™ of Young modulus of approximately 90 GPa, which yields a Young modulus of about 53 GPa for the composite material.

In the case of a driving mechanism having only a single spring, a spring of composite material can store a quantity of energy equivalent to that of a conventional steel spring when wound up, but the steel spring, typically thinner, restitutes the stored energy with a low torque and over a large number of turns, whilst the spring of composite material delivers it with a greater torque and a reduced number of turns. It is the stiffness and especially thickness of the springs of composite material that are responsible for this situation. Advantageously, the driving mechanism 1 according to the configuration of FIG. 1 enables the two springs 8, 11 to be mounted serially and thus their stiffness to be diminished whilst keeping thicknesses adapted to said composite materials.

Accordingly, a driving mechanism for watch movement is provided having: a barrel mounted on an arbor so as to be capable of turning around an axis of the arbor when the driving mechanism is wound up; a mainspring unit having a first and second spring coiled up inside the barrel in superimposed fashion and coaxial one relative to the other, wherein the first and second springs are coupled at one of their extremities to the barrel and to the arbor, respectively; wherein the unit further comprises a plate mounted coaxially between the two springs; wherein the plate is mounted rotatively on the axis; and wherein the first and second springs are coupled at their other extremity to the centre and to the periphery of the plate, respectively, so that the two springs simultaneously wind up around the axis when the driving mechanism is wound up. The driving mechanism has a power reserve greater than that of conventional driving mechanisms whilst having a long service life and maximizing the restitution of the stored energy.

### REFERENCE NUMBERS USED IN THE FIGURES

1 driving mechanism

2 barrel

3 arbor

4 arbor axis

6 outer drum

7 bottom of the barrel

8 first spring

9 outer extremity of the first spring

10 inner extremity of the first spring

11 second spring

12 inner extremity of the second spring

13 outer extremity of the second spring

14 plate

15 plate periphery, edge

16 plate center

17 plate hub

1. Driving mechanism for watch movement, comprising
a barrel mounted on an arbor so as to be capable of turning around an axis of the arbor when the driving mechanism is wound up;
a mainspring unit comprising a first spring and second spring coiled up inside the barrel in superimposed fashion and coaxial one relative to the other, wherein the first spring is coupled at one of its extremities to the barrel and the second spring is coupled at one of its extremities to the arbor; wherein the unit further comprises a plate mounted coaxially between the two springs; wherein
the plate is mounted rotatively around the axis; and wherein
the first spring is coupled at its other extremity to the centre and the second spring is coupled at its other extremity to the periphery of the plate, so that the two springs simultaneously wind up around the axis when the driving mechanism is wound up.

2. The driving mechanism according to claim 1, wherein the first spring is wound in the opposite direction to the second spring.

3. The driving mechanism according to claim 1, wherein the plate comprises a hub engaging in pivoting fashion onto the arbor, wherein the lower extremity of the first spring is fastened onto the hub.

4. The driving mechanism according to claim 1, wherein the periphery of the plate has an edge onto which the outer extremity of the second spring is fastened.

5. The driving mechanism according to claim 1, comprising several mainspring units mounted serially.

6. The driving mechanism according to claim 1, wherein the first and second springs are made of fiber-reinforced polymer.

7. The driving mechanism according to claim 6, wherein the fibers are oriented unidirectionally in the polymer matrix.

8. Timepiece having a driving mechanism comprising
a barrel mounted on an arbor so as to be capable of turning around an axis of the arbor when the driving mechanism is wound up;
a mainspring unit having a first spring and second spring coiled up inside the barrel in superimposed fashion and coaxial one relative to the other, the first spring being coupled at one of its extremities to the barrel and the second spring being coupled at one of its extremities to the arbor;
the unit further comprising a plate mounted coaxially between the two springs; wherein the plate is mounted rotatively around the axis; and wherein the first spring is coupled at its other extremity to the centre and the second spring is coupled at its other extremity to the periphery of the plate, so that the two springs simultaneously wind up around the axis when the driving mechanism is wound up.
